(19) United States
(12) Patent Application Publication
(10) Pub. No.: US 2006/0086668 A1
(43) Pub. Date: Apr. 27, 2006

(54) Method for reducing fluoride ion content in calcium chloride

(76) Inventors: Manoj V. Bhinde, Boothwyn, PA (US); Michael J. Geiger, Newark, DE (US)

Correspondence Address: Robert A. Koons, Jr.;Buchanan Ingersoll PC, 14th Floor, 1835 Market Street, Philadelphia, PA, 19103-2985, US

(21) Appl. No.: 10/973,565

(22) Filed: Oct. 26, 2004

(51) Int. Cl. C02F 1/28

(52) U.S. Cl. 210/670; 210/683

(57) ABSTRACT

The content of fluoride ions in aqueous solutions of calcium chloride is reduced by contacting with activated alumina. The contacting can be accomplished either as a batch slurry process or a continuous process using a fixed bed. The adsorption rate of fluoride ions by the activated alumina is increased by pre-treating the alumina with either an aqueous acid or a sulfate solution. Spent alumina can be regenerated by washing with dilute caustic.

### FIELD OF THE INVENTION

The present invention is related generally to processes of reducing ppm quantities of ions in aqueous solutions. More specifically, the present invention relates to processes for reducing ppm quantities of fluoride ions in concentrated solutions of calcium chloride using activated alumina.

### BACKGROUND OF THE INVENTION

Calcium chloride is used in different applications, some of which require “food-grade” calcium chloride that contains low concentrations of fluoride and other contaminants. For example, calcium chloride is used in bisphenol-A plants to break the hydrochloric acid/water azeotrope in hydrochloric acid recovery columns. In this particular application, fluoride ions will concentrate and convert to hydrogen fluoride in the HCl recovery column. Hydrogen fluoride, known to dissolve glass, creates pinholes in the recovery column, disrupting the recovery process and creating leakage problems. “Food grade” calcium chloride is also used in actual food applications, which naturally require high quality materials.

The fluoride concentration in “food-grade” calcium chloride is typically less than 10 ppm. However, this grade of calcium chloride is often difficult to obtain and is therefore expensive. It would thus be desirable to remove the fluoride ions from an industrial grade calcium chloride solution prior to its use in applications requiring low-fluoride, or “food grade” quality calcium chloride. Many present methods for removing fluoride ions from process and wastewater streams are inadequate or cost prohibitive for obtaining the desired fluoride-free calcium chloride solution because they are inapplicable when calcium and chloride concentrations are high. U.S. Pat. No. 6,355,221 to Rappas and U.S. Pat. No. 5,403,495 to Kust et al. teach the use of calcium fluoride as a seed for creating enhanced calcium fluoride particles in order to remove soluble fluoride from the wastewater streams.

The use of adsorbents to remove fluoride ions in solution has also been effective under certain conditions. For example, European Patent No. EP0191893 to Nomura et al. discloses contacting a solution containing fluorine compounds with various hydrated rare earth oxide adsorbents. Similarly, International Publication No. WO 98/10851 teaches the removal of fluoride ions in solution by passing the solution through an ion exchange resin to produce an ultra-pure hydrofluoric acid. However, these methods do not solve the problem of removing fluoride ions from solutions containing high calcium and chloride ion concentrations, thereby generating a purified calcium chloride stream for use in later processing. These methods also do not produce a calcium chloride solution with as little as 1 ppm or less of fluoride.

Alumina has been used extensively in the treatment of drinking water to remove unacceptably high concentrations of fluoride ions. However, only limited work has been done using aqueous solutions containing high concentrations of other ions. In “The Removal of Fluoride From Waters by Adsorption”, Choi et al, Water Technology and Quality, Journal AWWA, p. 562-69, 1979, several experiments were performed removing fluoride ions from solutions of varying salinity, but at a maximum of 33 g/kg, 3.3 percent by weight, at a fluoride concentration of 20 mg/L. This same paper reports that seawater with a salinity above 10 g/kg caused objectionable precipitation effects at fluoride levels higher than 20 mg/L. On the other hand, industrial grade calcium chloride solutions are generally supplied at concentrations from 28 to 39 percent calcium chloride by weight.

It would therefore be advantageous to have an easy, cost-effective method for reducing the fluoride ion content of industrial calcium chloride solutions.

### SUMMARY OF THE INVENTION

The present invention provides a method for reducing the concentration of fluoride ions in aqueous solutions of calcium chloride. The method comprises providing an aqueous calcium chloride solution containing calcium chloride at a concentration of from about 10 to about 50 percent by weight, and also containing an unacceptably high concentration of fluoride ions, and treating the aqueous calcium chloride solution with an activated alumina to affect a reduction in the concentration of fluoride ions. The activated alumina treatment may be accomplished either by a batch slurry process or a continuous process, in which the activated alumina is in the form of a fixed bed. Preferably, the alumina is in the form of a fixed bed over which the calcium chloride solution is passed.

In an alternative embodiment of the invention, the alumina may be treated with an aqueous acid or sulfate solution prior to contacting with the calcium chloride solution. Such treatment improves the adsorption of fluoride ions by the alumina. In the case of a slurry process, the acid treatment may be performed concurrently with the formation of calcium chloride solution from calcium carbonate or calcium oxide and hydrochloric acid. In the case of a fixed alumina bed process, the acid or sulfate treatment is a pre-treatment.

In addition, the present invention provides a method for regenerating spent alumina by washing with caustic, followed by an acid wash, with optional water washed following the caustic and acid washes.

### DETAILED DESCRIPTION OF THE INVENTION

Reduction of the concentration of fluoride ions in aqueous solutions of calcium chloride is affected by contacting a concentrated solution of calcium chloride with activated alumina. The activated alumina may be of any type normally used in industrial applications. Smaller mesh size alumina particles are preferred in general as they supply greater accessible internal surface area per gram for adsorbing fluoride ions.

Industrial grade solutions of calcium chloride are commonly provided by a supplier in concentrations ranging from 28 to 39 percent by weight and contain up to 100 parts per million (ppm) of fluoride ions. Such concentrations of fluoride ions can be detrimental to process equipment where calcium chloride solutions are used in petrochemical processes. In addition, such concentrations exceed the allowable content of fluoride in calcium chloride in food applications. Although most industrial grade solutions of calcium chloride are supplied at concentrations of 28 to 39 percent by weight, it will be recognized that the present process will not be limited to a particular concentration of calcium chloride solution. It is expected that aqueous solutions of from about 10 percent to about 50 percent calcium chloride by weight will be economically attractive.

The current process is capable of reducing fluoride ion content in solutions of calcium chloride down to a concentration of less than 1 ppm.

The process of the current invention may be practiced either as a batch slurry process or preferably as a continuous process, in which the activated alumina is in the form of a fixed bed, over which the calcium chloride solution is passed. In the slurry process, the quantity of alumina used will range from about 0.5 to about 10 percent by weight based on the calcium chloride solution.

Since the kinetics involved in the adsorption of fluoride ions by the alumina bed are somewhat slow, the contact time of the solution with the alumina is of critical importance to achieve the desired reduction of fluoride ions. For example, in the fixed bed embodiment of the process typical flow rates of 0.1 to 2.0 pounds of solution per pound of alumina per hour are attainable with a reduction in fluoride ions to less than 1 ppm for an activated alumina bed that has not been pre-treated. Of course if higher concentrations of fluoride ions, such as 10 ppm or less, are acceptable higher flow rates can be used to achieve that result. Therefore, the actual flow rate achieved in the practice of the invention will depend on the total quantity of fluoride ions desired in the calcium chloride solution, as well as the concentration of fluoride ions in the un-treated calcium chloride solution.

At any desired final concentration of fluoride ions, higher throughputs can be attained if, prior to passing the calcium chloride solution through the alumina bed, the bed is pre-treated with a dilute aqueous acid or a sulfate solution. Suitable acids include the non-limiting examples: hydrochloric and sulfuric acid. Suitable sulfates include the non-limiting examples: sodium sulfate, aluminum sulfate and ammonium sulfate. For example, once the alumina bed has been pre-treated, flow rates of up to 10 pounds of solution per pound of alumina per hour can be attained while still achieving a reduction in fluoride ions to less than 1 ppm in the effluent. Again if higher fluoride concentrations are acceptable, then even higher flow rates can be used.

In the case of a slurry process, total contact time for the batch will be determined based on the desired concentration of fluoride ions in the final product, as well as the concentration of fluoride ions in the un-treated calcium chloride solution and the quantity of alumina used. Of course acid or sulfate pre-treatment will result in shorter contact times. In the case of a slurry process, the acid treatment may be performed concurrently with the formation of calcium chloride solution from calcium carbonate or calcium oxide and hydrochloric acid. It should be noted however, that pre-treatment of the alumina bed does not increase the overall capacity of the alumina to adsorb fluoride ions. Thus, although pre-treatment allows higher flow rates or shorter contact times for a given reduction in fluoride concentration, the higher flow rates necessarily result in shorter bed life at a given concentration of fluoride ions.

Once the activated alumina is spent, i.e. it has adsorbed sufficient fluoride ions such that it can no longer efficiently remove additional ions, the alumina can be regenerated by washing with dilute caustic followed by an optional water wash. Caustic solutions of from about 0.1 to about 2 percent by weight are suitable for use with the current invention. Following the caustic wash, or the optional water wash, the alumina is treated with an aqueous acid or sulfate solution. Following the acid wash the alumina again may optionally be washed with water.

The invention will now be further described by reference to the following examples. Several samples of calcium chloride solution containing approximately 20 ppm of fluoride ions were treated by contacting with a activated alumina. The activated aluminas used in the examples are transition aluminas, which are mixtures of chi, eta and boehmite forms. These aluminas were obtained from Alcan International, Ltd.

### EXAMPLE 1

A calcium chloride solution containing 22 ppm of fluoride ions, as determined by ion selective electrode, was treated by slurrying with 28×48 mesh AA400 activated alumina, available from Alcan International, Ltd., that was not acid or sulfate pre-treated. Approximately 200 grams of solution was slurried with 5 grams of 28×48 mesh alumina at 22° C. The results are shown in Table 1.

TABLE 1
Untreated Alumina

| Sample | Elapsed time, | Fluoride |
|---|---|---|
| ID | minutes | ppm |
| 505-110-0 | 0 | 22.0 |
| 505-110-1 | 5 | 16.0 |
| 505-110-2 | 15 | 14.7 |
| 505-110-3 | 30 | 14.1 |
| 505-110-4 | 60 | 6.9 |
| 505-110-5 | 120 | 4.0 |
| 505-110-6 | 240 | 2.8 |
| 505-110-7 | 360 | 2.0 |
| 505-110-8 | 1380 | 1.7 |

### EXAMPLE 2

A calcium chloride solution containing 18.2 ppm of fluoride ions, as determined by ion selective electrode, was treated by slurrying with 28×48 mesh AA400 activated alumina that had been pre-treated by contacting with hydrochloric acid. Approximately 200 grams of solution was slurried with 5 grams of 28×48 mesh alumina at 22° C. The results are shown in Table 2.

TABLE 2
HCl Treated Alumina

| Sample | Elapsed time, | Fluoride |
|---|---|---|
| ID | minutes | ppm |
| 505-95-0 | 0 | 18.2 |
| 505-95-1 | 5 | 11.6 |
| 505-95-2 | 15 | 8.5 |
| 505-95-3 | 30 | 5.1 |
| 505-95-4 | 60 | 2.1 |
| 505-95-5 | 120 | 1.3 |
| 505-95-6 | 240 | 1.3 |
| 505-95-7 | 360 | 1.3 |

### EXAMPLE 3

A calcium chloride solution containing 20.8 ppm of fluoride ions, as determined by ion selective electrode, was treated by slurrying with 28×48 mesh AA400 activated alumina that had been pre-treated by contacting with sulfuric acid. Approximately 200 grams of solution was slurried with 5 grams of alumina at 22° C. The results are shown in Table 3.

TABLE 3
H₂SO₄ Treated Alumina

| Sample | Elapsed time, | Fluoride |
|---|---|---|
| ID | minutes | ppm |
| 505-100-0 | 0 | 20.8 |
| 505-100-1 | 5 | 11.8 |
| 505-100-2 | 15 | 4.7 |
| 505-100-3 | 30 | 3.0 |
| 505-100-4 | 60 | 1.3 |
| 505-100-5 | 120 | 0.8 |
| 505-100-6 | 240 | 0.8 |
| 505-100-7 | 360 | 0.8 |
| 505-100-8 | 1390 | 0.7 |

As can be seen from the results reported in Tables 1, 2 and 3, the pre-treatment of the activated alumina with an acid increases the adsorption rate of fluoride on the alumina. In Example 1, a fluoride reduction from 22 ppm to less than 7 ppm required 60 minutes of contact time. In Example 2, a reduction from 18.2 ppm to 8.5 ppm was accomplished in 15 minutes. In Example 3, a reduction from 20.8 ppm to less than 5 ppm was accomplished in 15 minutes.

### EXAMPLE 4

A calcium chloride solution containing 19.5 ppm of fluoride ions, as determined by ion selective electrode, was treated by slurrying with un-treated 8×14 mesh AA400 activated alumina, available from Alcan International, Ltd. Approximately 200 grams of solution was slurried with 5 grams of alumina at 22° C. The results are shown in Table 4.

TABLE 4
Un-Treated Alumina

| Sample | Elapsed time, | Fluoride |
|---|---|---|
| ID | minutes | ppm |
| 505-93-0 | 0 | 19.5 |
| 505-93-1 | 5 | 20.1 |
| 505-93-2 | 15 | 20.8 |
| 505-93-3 | 30 | 22.3 |
| 505-93-4 | 60 | 15.3 |
| 505-93-5 | 120 | 14.9 |
| 505-93-6 | 240 | 13.9 |
| 505-93-7 | 360 | 8.7 |
| 505-93-8 | 1365 | 6.6 |
| 505-93-9 | 1815 | 5.4 |
| 505-93-10 | 2775 | 4.1 |

### EXAMPLE 5

A calcium chloride solution containing 20.8 ppm of fluoride ions, as determined by ion selective electrode, was treated by slurrying with 8×14 mesh AA400 activated alumina pre-treated with aluminum sulfate. Approximately 200 grams of solution was slurried with 5 grams of alumina at 22° C. The results are shown in Table 5.

TABLE 5
Aluminum Sulfate Treated

| Sample | Elapsed time, | Fluoride |
|---|---|---|
| ID | minutes | ppm |
| 505-103-0 | 0 | 20.8 |
| 505-103-1 | 5 | 16.5 |
| 505-103-2 | 15 | 16.3 |
| 505-103-3 | 30 | 14.0 |
| 505-103-4 | 60 | 11.8 |
| 505-103-5 | 120 | 7.5 |
| 505-103-6 | 240 | 4.0 |
| 505-103-7 | 360 | 4.6 |
| 505-103-8 | 5695 | 1.4 |

### EXAMPLE 6

A calcium chloride solution containing 19.5 ppm of fluoride ions, as determined by ion selective electrode, was treated by slurrying with un-treated 8×14 mesh AA300 activated alumina, also available from Alcan International, Ltd. Approximately 200 grams of solution was slurried with 5 grams of alumina at 22° C. The results are shown in Table 6.

TABLE 6
Un-Treated Alumina

| Sample | Elapsed time, | Fluoride |
|---|---|---|
| ID | minutes | ppm |
| 505-92-0 | 0 | 19.5 |
| 505-92-1 | 5 | 16.9 |
| 505-92-2 | 15 | 15.1 |
| 505-92-3 | 30 | 15.7 |
| 505-92-4 | 60 | 15.4 |
| 505-92-5 | 120 | 14.0 |
| 505-92-6 | 240 | 10.6 |
| 505-92-7 | 360 | 8.8 |
| 505-92-8 | 1365 | 4.0 |
| 505-92-9 | 1815 | 3.3 |
| 505-92-10 | 2775 | 2.5 |

### EXAMPLE 7

A calcium chloride solution containing 20.8 ppm of fluoride ions, as determined by ion selective electrode, was treated by slurrying with 8×14 mesh AA300 activated alumina pre-treated with aluminum sulfate. Approximately 200 grams of solution was slurried with 5 grams of alumina at 22° C. The results are shown in Table 7.

TABLE 7
Aluminum Sulfate Treated

| Sample | Elapsed time, | Fluoride |
|---|---|---|
| ID | minutes | ppm |
| 505-102-0 | 0 | 20.8 |
| 505-102-1 | 5 | 16.2 |
| 505-102-2 | 15 | 15.7 |
| 505-102-3 | 30 | 14.1 |
| 505-102-4 | 60 | 9.8 |
| 505-102-5 | 120 | 4.3 |
| 505-102-6 | 240 | 0.9 |
| 505-102-7 | 360 | 2.2 |
| 505-102-8 | 5700 | 0.8 |

The data in Tables 4 through 7 demonstrate the improvement in fluoride adsorption obtained by pre-treating two different grades of activated alumina with a sulfate solution. In both Examples 4 and 6 a total of 360 minutes was required to attain a fluoride ion reduction to less than 10 ppm. In Examples 5 and 7, a reduction in fluoride ions to less than 10 ppm was achieved in 120 minutes and 60 minutes respectively. Also, comparing the results for Examples 1 and 4 it can be seen that for a given grade of activated alumina, a smaller mesh size results in a more rapid adsorption of fluoride ions. While not wishing to be bound by theory, the inventors believe that this is a result of the greater availability of useful internal surface area per gram in the smaller mesh size material.

### EXAMPLES 8 THROUGH 14

A series of samples of calcium chloride solution containing from 17.5 to 19.3 ppm of fluoride ions were treated by passing the solutions over a bed of activated alumina. All of the examples used 28×48 mesh Alcan AA400, except for Example 14, which used 8×14 mesh Alcan AA300 alumina. Samples were run at approximately 20° C., room temperature, to 55° C. Although it is not believed that temperature will have an impact on the adsorption of fluoride ions, it has been found that temperatures in excess of 60° C. result in the generation of excessive alumina fines. Therefore, the practical upper limit on the temperature for the process of the current invention is set based on the temperature stability of the alumina used.

Table 8 through 14 show the results from Examples 8 through 14. The tables indicate temperature, rate in grams of solution per minute, total grams of solution and total bed turnovers. A bed turnover is defined as one weight equivalent of solution being passed through the alumina bed. For example, for a 5 gram alumina bed, one bed turnover is represented by 5 grams of calcium chloride solution.

TABLE 8
Un-Treated

| | Pump | | | | Bed | Effluent | Feed |
|---|---|---|---|---|---|---|---|
| | setting, | Temp, | | | Turnovers | Fluoride, | Fluoride, |
| Sample ID | cc/min | deg C. | Rate, g/min | Cum wt., g | wt./wt. | ppm | ppm |
| 505-59-1 | 0.1 | 55 | 0.032 | 4.5 | 0 | 0.3 | 17.5 |
| 505-59-2 | 0.1 | 55 | 0.146 | 137.7 | 7 | 0.3 | 17.5 |
| 505-59-3 | 0.1 | 55 | 0.155 | 202.7 | 10 | 0.5 | 17.5 |
| 505-59-4 | 0.1 | 55 | 0.146 | 782.2 | 39 | 0.5 | 17.5 |
| 505-59-5 | 0.1 | 55 | 0.145 | 850.4 | 42 | 0.6 | 17.5 |
| 505-59-6 | 0.1 | 55 | 0.145 | 995.8 | 50 | 0.8 | 17.5 |
| 505-59-7 | 0.1 | 55 | 0.148 | 1058.6 | 53 | 1.0 | 17.5 |
| 505-59-8 | 0.1 | 55 | 0.147 | 1205.2 | 60 | 1.6 | 17.5 |
| 505-59-9 | 0.1 | 55 | 0.147 | 1269.2 | 63 | 3.0 | 17.5 |
| 505-59-10 | 0.1 | 55 | 0.147 | 1416.6 | 70 | 4.4 | 17.5 |
| 505-59-11 | 0.1 | 55 | 0.145 | 1474.6 | 73 | 6.0 | 17.5 |
| 505-59-12 | 0.1 | 55 | 0.146 | 1639.9 | 82 | 8.8 | 17.5 |

TABLE 9
Un-Treated

| | Pump | | | | Bed | Effluent | Feed |
|---|---|---|---|---|---|---|---|
| | setting, | Temp, | | | Turnovers | Fluoride, | Fluoride, |
| Sample ID | cc/min | deg C. | Rate, g/min | Cum wt., g | wt./wt. | ppm | ppm |
| 505-67-1 | 0.1 | 21 | 0.066 | 27.7 | 1 | 1.0 | 17.5 |
| 505-67-2 | 0.1 | 21 | 0.147 | 170.8 | 9 | 1.2 | 17.5 |
| 505-67-3 | 0.1 | 21 | 0.143 | 239.6 | 13 | 0.4 | 17.5 |
| 505-67-4 | 0.1 | 20 | 0.146 | 380 | 20 | 0.5 | 17.5 |
| 505-67-5 | 0.1 | 21 | 0.142 | 433.2 | 23 | 0.9 | 17.5 |
| 505-67-6 | 0.1 | 21 | 0.144 | 1005.1 | 53 | 1.2 | 17.5 |
| 505-67-7 | 0.1 | | 0.147 | 1077.3 | 57 | 4.6 | 17.5 |
| 505-67-8 | 0.1 | | 0.145 | 1213.2 | 64 | 4.8 | 17.5 |
| 505-67-9 | 0.1 | | 0.145 | 1228.4 | 65 | | 17.5 |

TABLE 10
Un-Treated

| | Pump | | | | Bed | Effluent | Feed |
|---|---|---|---|---|---|---|---|
| | setting, | Temp, | Rate, | | Turnovers | Fluoride, | Fluoride, |
| Sample ID | cc/min | deg C. | g/min | Cum wt., g | wt./wt. | ppm | ppm |
| 505-75-1 | 0.1 | 21 | 0.015 | 3 | 0 | 1.0 | 17.5 |
| 505-75-2 | 0.1 | 21 | 0.092 | 222.5 | 11 | 0.5 | 17.5 |
| 505-75-3 | 0.1 | 21 | 0.031 | 236.3 | 11 | 2.3 | 17.5 |
| 505-75-4 | 0.1 | 20 | 0.025 | 260.9 | 13 | 0.6 | 17.5 |
| 505-75-5 | 0.1 | 21 | 0.145 | 322.5 | 16 | 0.4 | 17.5 |
| 505-75-6 | 0.1 | 21 | 0.176 | 778.5 | 38 | 0.4 | 17.5 |
| 505-75-7 | 0.1 | 21 | 0.145 | 967.7 | 47 | 1.8 | 17.5 |
| 505-75-8 | 0.1 | 21 | 0.144 | 1036.2 | 50 | 5.3 | 17.5 |
| 505-75-9 | 0.1 | 21 | 0.145 | 1173.5 | 57 | 14.2 | 17.5 |
| 505-75-10 | 0.1 | 22 | 0.139 | 1238.3 | 60 | 37.7 | 17.5 |
| 505-75-11 | 0.1 | 22 | 0.149 | 1384.8 | 67 | 8.8 | 17.5 |
| 505-75-12 | 0.1 | 22 | 0.131 | 1430.6 | 69 | 38.0 | 17.5 |

TABLE 11
Un-Treated

| | Pump | | | | Bed | Effluent | Feed |
|---|---|---|---|---|---|---|---|
| | setting, | Temp, | Rate, | | Turnovers | Fluoride, | Fluoride, |
| Sample ID | cc/min | deg C. | g/min | Cum wt., g | wt./wt. | ppm | ppm |
| 505-82-1 | 0.2 | 21 | 0.158 | 39.4 | 2 | 0.3 | 17.5 |
| 505-82-2 | 0.2 | 21 | 0.310 | 81.2 | 4 | 0.5 | 17.5 |
| 505-82-3 | 0.2 | 22 | 0.314 | 419.1 | 22 | 0.4 | 17.5 |
| 505-82-4 | 0.1 | 21 | 0.092 | 450.0 | 24 | 0.7 | 18.8 |
| 505-82-5 | 0.1 | 22 | 0.117 | 899.8 | 48 | 0.3 | 18.8 |
| 505-82-6 | 0.1 | 22 | 0.111 | 946.5 | 50 | | 18.8 |
| 505-82-7 | 0.1 | 22 | 0.131 | 1081.5 | 57 | 0.3 | 18.8 |
| 505-82-8 | 0.1 | 22 | 0.119 | 1149.0 | 61 | 0.3 | 18.8 |
| 505-82-9 | 0.1 | 19 | 0.124 | 1265.1 | 67 | 0.5 | 18.8 |
| 505-82-10 | 0.1 | 21 | 0.120 | 1310.1 | 69 | 0.7 | 18.8 |
| 505-82-11 | 0.1 | 21 | 0.117 | 1427.6 | 76 | 1.1 | 18.8 |
| 505-82-12 | 0.1 | 21 | 0.109 | 1475.7 | 78 | | 18.8 |
| 505-82-13 | 0.1 | 21 | 0.110 | 1587.2 | 84 | 2.0 | 18.8 |
| 505-82-14 | 0.1 | 21 | 0.093 | 1621.9 | 86 | 3.9 | 18.8 |

TABLE 12
Un-Treated

| | Pump | | | | Bed | Effluent | Feed |
|---|---|---|---|---|---|---|---|
| | setting, | Temp, | Rate, | | Turnovers | Fluoride, | Fluoride, |
| Sample ID | cc/min | deg C. | g/min | Cum wt., g | wt./wt. | ppm | ppm |
| 505-88-1 | 0.4 | 19 | 0.098 | 5.9 | 0 | 0.9 | 19.3 |
| 505-88-2 | 0.4 | 19 | 0.683 | 46.9 | 2 | 0.3 | 19.3 |
| 505-88-3 | 0.4 | 20 | 0.595 | 82.6 | 4 | 0.5 | 19.3 |
| 505-88-4 | 0.4 | 20 | 0.575 | 117.1 | 6 | 0.2 | 19.3 |
| 505-88-5 | 0.4 | 20 | 0.591 | 155.5 | 8 | 0.6 | 19.3 |
| 505-88-6 | 0.4 | 20 | 0.631 | 190.2 | 9 | 0.6 | 19.3 |
| 505-88-7 | 0.4 | 19 | 0.592 | 734.6 | 35 | 0.1 | 19.3 |
| 505-88-8 | 0.4 | 19 | 0.545 | 770 | 37 | 0.3 | 19.3 |
| 505-88-9 | 1.0 | 19 | 1.538 | 831.5 | 40 | 1.0 | 19.3 |
| 505-88-10 | 1.0 | 19 | 1.252 | 940.4 | 45 | 1.1 | 19.3 |
| 505-88-11 | 1.0 | 19 | 1.685 | 1029.7 | 50 | 3.8 | 19.3 |
| 505-88-12 | 1.0 | 20 | 1.437 | 1130.3 | 55 | 5.5 | 19.3 |
| 505-88-13 | 1.0 | 20 | 1.345 | 1204.3 | 58 | 7.3 | 19.3 |
| 505-88-14 | 1.0 | 20 | 1.434 | 1297.5 | 63 | 9.0 | 19.3 |
| 505-88-15 | 1.0 | 20 | 1.353 | 1392.2 | 67 | 10.7 | 19.3 |

TABLE 13
Aluminum Sulfate Treated

| | Pump | | | | Bed | Effluent | Feed |
|---|---|---|---|---|---|---|---|
| | setting, | Temp, | Rate, | | Turnovers | Fluoride, | Fluoride, |
| Sample ID | cc/min | deg C. | g/min | Cum wt., g | wt./wt. | ppm | ppm |
| 505-98-1 | 3.0 | 20 | 3.673 | 110.2 | 5 | 0.6 | 18.8 |
| 505-98-2 | 3.0 | 20 | 3.463 | 214.1 | 10 | 0.7 | 18.8 |
| 505-98-3 | 3.0 | 20 | 3.560 | 320.9 | 16 | 0.8 | 18.8 |
| 505-98-4 | 3.0 | 20 | 3.404 | 474.1 | 23 | 0.9 | 18.8 |
| 505-98-5 | 3.0 | 20 | 3.360 | 625.3 | 30 | 1.0 | 18.8 |
| 505-98-6 | 3.0 | 20 | 3.158 | 783.2 | 38 | 1.1 | 18.8 |
| 505-98-7 | 3.0 | 20 | 3.395 | 919.0 | 44 | 1.5 | 18.8 |
| 505-98-8 | 3.0 | 20 | 3.102 | 1058.6 | 51 | 1.8 | 18.8 |
| 505-98-9 | 3.0 | 20 | 2.977 | 1201.5 | 58 | 2.6 | 18.8 |
| 505-98-10 | 3.0 | 20 | 2.868 | 1327.7 | 64 | 3.3 | 18.8 |

TABLE 14
Un-Treated

| | Pump | | | | Bed | Effluent | Feed |
|---|---|---|---|---|---|---|---|
| | setting, | Temp, | Rate, | | Turnovers | Fluoride, | Fluoride, |
| Sample ID | cc/min | deg C. | g/min | Cum wt., g | wt./wt. | ppm | ppm |
| 505-90-1 | 0.1 | 20 | 0.088 | 31.5 | 2 | 1.4 | 18.1 |
| 505-90-2 | 0.1 | 18 | 0.152 | 628.8 | 30 | 3.7 | 18.1 |
| 505-90-3 | 0.1 | 18 | 0.153 | 667 | 32 | 8.1 | 18.1 |
| 505-90-4 | 0.2 | 18 | 0.298 | 729.5 | 35 | 10.7 | 18.1 |
| 505-90-5 | 0.2 | 18 | 0.301 | 1027.3 | 50 | 12.2 | 18.1 |
| 505-90-6 | 0.2 | 18 | 0.301 | 1153.8 | 56 | 15.9 | 18.1 |
| 505-90-7 | 0.1 | 18 | 0.153 | 1312.3 | 63 | 13.2 | 18.1 |

The data in Tables 8 through 14 demonstrate that it is possible to achieve reductions in fluoride ions to less than 1 ppm for up to 76 bed turnovers.

Comparing Tables 11 and 12, it can be seen that an increase in the flow rate for an untreated alumina bed results in a smaller reduction in fluoride ion content. The flow rate utilized in any embodiment of the current invention will be determined based on the content of fluoride ions desired in the final calcium chloride solution, as well as the content of fluoride in the solution fed to the process. For some applications, a fluoride content of 10 ppm or less is considered acceptable. Where this is the case, a manufacturer who desires high throughput and wants to maximize the tonnage of calcium chloride processed by a given quantity of alumina, will be able to use higher flow rates to achieve this result. Alternatively, where a manufacturer desires a fluoride content of less than 1 ppm, slower flow rates will be appropriate.

Looking to Table 13, it can be seen that pre-treating an activated alumina bed with aluminum sulfate allows significantly higher flow rates, while still achieving significant reductions in the fluoride content of the effluent.

### EXAMPLE 15

A spent alumina bed containing 5 grams of activated alumina was regenerated by treatment with caustic. The bed was first washed with 50 mL of 1 percent caustic solution to remove adsorbed fluoride ions. The bed was then washed with 100 mL of water. The alumina bed was then treated with 90 mL of 0.355% aqueous HCl, followed by a 60 mL water wash. Table 15 shows the results achieved treating a calcium chloride solution containing 22.8 ppm of fluoride with the regenerated alumina bed.

TABLE 15
Regenerated Alumina Bed

| | Pump | | | | Bed | Effluent | Feed |
|---|---|---|---|---|---|---|---|
| | setting, | Temp, | Rate, | | Turnovers | Fluoride, | Fluoride, |
| Sample ID | cc/min | deg C. | g/min | Cum wt. gr | wt./wt. | ppm | ppm |
| 505-109-1 | 0.8 | 21 | 0.374 | 39.3 | 2 | 0.5 | 22.8 |
| 505-109-2 | 0.8 | 21 | 0.360 | 337 | 16 | 0.7 | 22.8 |
| 505-109-3 | 0.8 | 21 | 0.242 | 370.2 | 18 | 1.0 | 22.8 |
| 505-109-4 | 0.8 | 21 | 0.506 | 423.3 | 20 | 0.9 | 22.8 |
| 505-109-5 | 3 | 21 | 3.543 | 529.6 | 26 | 1.6 | 22.8 |
| 505-109-6 | 3.0 | 21 | 3.412 | 666.1 | 32 | 4.3 | 22.8 |
| 505-109-7 | 3 | 21 | 3.860 | 743.3 | 36 | 7.3 | 22.8 |
| 505-109-8 | 3.0 | 21 | 3.097 | 836.2 | 40 | 11.9 | 22.8 |
| 505-109-9 | 3.0 | 21 | 3.163 | 931.1 | 45 | 9.4 | 22.8 |
| 505-109-10 | 0.8 | 21 | 1.083 | 996.1 | 48 | 8.7 | 22.8 |
| 505-109-11 | 0.8 | 21 | 1.125 | 1063.6 | 51 | 7.6 | 22.8 |
| 505-109-12 | 0.8 | 21 | 1.103 | 1129.8 | 55 | 7.6 | 22.8 |

As can be seen from the data in Table 15, acceptable reductions in fluoride content were achieved using the regenerated alumina bed.

The invention has thus been described in detail with reference to the Examples. However, those skilled in the art will recognize that variations on these examples are possible without departing from the scope of the present invention.

What is claimed is:

1. A method for removing fluoride from calcium chloride, the method comprising:
providing an aqueous calcium chloride solution containing calcium chloride at a concentration of from about 10 to about 50 percent by weight, and also containing fluoride ions; and
contacting said aqueous calcium chloride solution with an activated alumina.

2. The method of claim 1, wherein said activated alumina is in a fixed bed and said calcium chloride solution is passed over said fixed bed.

3. The method according to claim 2, wherein, prior to passing said aqueous calcium chloride solution over said fixed bed, said activated alumina is pre-treated with an aqueous acid or sulfate solution.

4. The method according to claim 1, wherein said aqueous calcium chloride solution contains calcium chloride at a concentration of from about 20 to about 40 percent by weight.

5. The method according to claim 2, wherein said aqueous calcium chloride solution contains calcium chloride at a concentration of from about 20 to about 40 percent by weight.

6. The method according to claim 2, wherein the fluoride content of said aqueous calcium chloride solution is reduced to less than about 10 ppm by weight.

7. The method according to claim 6, wherein the fluoride content of said aqueous calcium chloride solution is reduced to less than about 1 ppm by weight.

8. The method according to claim 7, wherein said aqueous calcium chloride solution is passed over said fixed bed at a rate of from about 0.1 to about 2.0 pounds of solution per pound of alumina per hour.

9. The method according to claim 7, wherein, prior to passing said aqueous calcium chloride solution over said fixed bed, said activated alumina is pre-treated with an aqueous acid or sulfate solution.

10. The method according to claim 9, wherein said aqueous calcium chloride solution is passed over said fixed bed at a rate of from about 0.1 to about 10.0 pounds of solution per pound of alumina per hour.

11. The method according to claim 2, further comprising:
regenerating said activated alumina bed, said regenerating comprising
washing said activated alumina bed with an aqueous caustic solution, and
washing said activated alumina bed with an aqueous acid or sulfate solution.

12. The method according to claim 11, further comprising,
washing said activated alumina bed with water after said washing with aqueous caustic, and washing said activated alumina bed with water after said washing with aqueous acid or sulfate solution.

13. The method according to claim 1, wherein
said calcium chloride solution is contacted with said activated alumina in a batch slurry process.

14. The method according to claim 13, wherein, prior to contacting said aqueous calcium chloride solution with said activated alumina, said activated alumina is pre-treated with an aqueous acid or sulfate solution.

15. The method according to claim 13, wherein said aqueous calcium chloride solution contains calcium chloride at a concentration of from about 20 to about 40 percent by weight.

16. The method according to claim 13, wherein the fluoride content of said aqueous calcium chloride solution is reduced to less than about 10 ppm by weight.

17. The method according to claim 16, wherein the fluoride content of said aqueous calcium chloride solution is reduced to less than about 1 ppm by weight.

18. The method according to claim 13, wherein said calcium chloride is slurried with from about 0.5 to about 10 percent by weight of activated alumina.

19. The method according to claim 13, wherein
said activated alumina is slurried with aqueous calcium carbonate, calcium oxide or a mixture thereof, and hydrochloric acid to form calcium chloride.
